(19) United States
(12) Patent Application Publication
(10) Pub. No.: US 2017/0040095 A1
(43) Pub. Date: Feb. 9, 2017

(54) SUPERCONDUCTING DEVICE AND METHOD FOR INDUCING LOW RELAXATION RATE IN SUPERCONDUCTING MATERIAL

(71) Applicant: U.S. Army Research Laboratory ATTN: RDRL-LOC-I, Adelphi, MD (US)

(72) Inventors: George A. Levin, Vero Beach, FL (US); Paul N. Barnes, Silver Spring, MD (US); Charles C. Rong, Silver Spring, MD (US)

(21) Appl. No.: 14/819,933

(22) Filed: Aug. 6, 2015

(51) Int. Cl. H01F 7/20; H01F 6/06; C22C 29/12; H01F 7/06

(52) U.S. Cl. CPC H01F 7/20; H01F 7/064; H01F 6/06; C22C 29/12

(57) ABSTRACT

Provided are devices for inducing a current in a closed loop superconducting material including a magnetic field source housed within a coil former substantially coaxial with the magnetic field source, and a base optionally in physical contact with a support tube. A closed loop superconducting material is held in a loop position by the coil former and the base such that current passing through the magnetic field source will produce a current in the superconducting material by induction. By a process of modified current sweep reversal, the rate of relaxation may be reduced in the superconducting material relative to the absence of a reversal.

### GOVERNMENT INTEREST

The invention described herein may be manufactured, used, and licensed by or for the United States Government.

### FIELD

The present invention relates generally to the field of superconducting materials. More specifically, a device is provided for inducing a current in a closed loop of superconducting material. Methods of reducing the current relaxation rate are provided as well.

### BACKGROUND

Superconducting materials have the ability to conduct electrical current with zero resistance when the materials are cooled below the material's transition temperature. Initial materials found to possess this property included materials such as Nb₃Sn with a critical temperature of 18.3° K. and NbT with a critical temperature of 10° K. An issue with these early recognized materials is that reaching the critical temperature is difficult to achieve and commonly requires the use of liquid helium.

The development of high temperature superconducting (HTS) materials addressed many of these concerns as these materials possess critical temperatures that are reachable by immersion in liquid nitrogen (77° K) instead of liquid helium. There are currently two types of HTS materials in use. The first generation materials represented by the bismuth-strontium-calcium-copper-oxide (BSSCO) materials have been commercially available since 1990. Such first generation materials are used to produce transmission cable, transformers, fault current collectors, motors and generators. Although these first generation materials addressed the problem of expensive cryogenics, production of these materials often relies on the use of very expensive silver making wide scale adoption of these materials economically difficult.

Second generation HTS materials based on rare-earth barium copper oxide (ReBCO) materials are appreciated to have superior performance in a magnetic field as well as improved mechanical properties. These conductors are able to carry high currents in background fields of 1.5-3 T even at a temperature of 77 K. Since the development of yttrium barium copper oxide (YBCO) in 1987, second-generation ReBCO materials have been hotly pursued for their reasonable cost coupled to their high I_{c} density, low dependency of the I_{c} on the external magnetic field, and good mechanical properties. The characteristics of the second generation HTS materials offer opportunities to develop ultra-high-field magnets. The use of these materials, however, has been hampered by the unavailability of satisfactory joining techniques and production issues. Some advances have been made in the formation of such joints, but their usefulness in large format applications has yet to be proven. Further, the use of such materials in large scale operations requires excellent quality control, and simple and effective methods of such quality control are presently lacking.

In addition, most applications that use persistent current require materials with high temporal stability, and coated second generation HTS materials typically exhibit enhanced relaxation rates relative to the low temperature materials, due in part to their higher operating temperatures. Thus, methods of controlling and reducing the relaxation rate in HTS materials are important to their adoption and wide scale use.

As such, new devices and methods of testing and operating HTS materials are needed.

### SUMMARY

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

Provided are devices operable for inducing a current in a superconducting material such as in the form of a superconducting loop. A device includes a magnetic field source, optionally in the form of a resistive solenoid where the magnetic field source forms a longitudinal axis; and a coil former housed inside or outside the magnetic field source and within a distance from the magnetic field source such that a magnetic field generated by the magnetic field source is of sufficient strength to induce a current in a superconducting loop if supported by the coil former. A superconducting material is optionally associated with the device, optionally the superconducting material having a closed loop structure wherein the closed loop forms a geometric axis normal to a plane of the closed loop and passing through a geometric center of the loop, said geometric axis substantially coaxial with or oriented at an angle to said longitudinal axis of said magnetic field source. In some aspects, a coil former is in physical contact with a base, the base optionally also in physical contact with the magnetic field source. Optionally, a magnetic field source has a diameter of 10 millimeters to 15 millimeters. In some aspects, a device also includes a support tube capable of supporting the magnetic field source optionally with the magnetic field source surrounding the support tube or internally housed in the support tube. Optionally, the support tube is formed of a material that includes or is brass. A power source is optionally included where the power source is capable of producing a current in the magnetic field source. In any aspect, a superconducting material, if present, is optionally formed of a material including a rare earth metal. The rare earth metal is optionally yttrium, samarium, neodymium, and/or gadolinium. In some aspects, a superconducting material includes barium copper oxide. Independent of the material a superconducting material is formed from, in some aspects, the superconducting material is formed of a plurality of independent layers of superconducting material that may be of the same or different materials. In some aspects, a current is flowing through the magnetic field source of the device. A current optionally has an amperage of 0.1 amperes to 10 amperes.

Also provided are methods of inducing a current in a superconducting material where the process results in an unexpectedly reduced relaxation rate in the superconducting material. A process includes generating a first primary current in a magnetic field source, optionally in a device as provided herein, the first primary current including a first polarity and flowing for a first time, the magnetic field source in electromagnetic contact with a superconducting material such that the first primary current produces a finite magnetic flux through the superconducting material, terminating the first primary current for a second time, generating a second magnetic flux by generating a second primary current with a second polarity through the magnetic field source for a third time, the second polarity opposite to the first polarity, and terminating said second primary current. The reversal of the current for the second time produces a current in the superconducting material that demonstrates a reduced rate of relaxation relative to a process that does not include the reversal method. The process is optionally performed on any device as provided herein, and using any superconducting material, optionally superconducting material in the form of a closed loop. High temperature superconducting materials may be used such as those that include a rare earth metal, optionally yttrium, samarium, neodymium, and/or gadolinium. Optionally, a superconducting material that may be induced to have a current resistive to relaxation includes barium copper oxide.

The processes and devices as provided herein provide a simple and effective means for inducing a current in a superconducting material, testing superconducting materials, or for creating current in such superconducting materials that are resistant to relaxation.

### BRIEF DESCRIPTION OF THE DRAWINGS

FIG. 1 illustrates one aspect of a magnetic field source in the form of a resistive solenoid surrounding a solenoid support tube affixed to a base such that the solenoid is substantially normal to the plane of the support;

FIG. 2A illustrates one aspect of a device whereby a coil former is surrounding a resistive solenoid and defining a geometric center of a closed loop of superconducting material;

FIG. 2B illustrates another aspect of a device from an increased vertical perspective relative to FIG. 2A;

FIG. 3 illustrates one aspect of a process for inducing a current in a superconducting material with a reduced relaxation rate where the time dependence of the electric current in the magnetic field source is shown which is used to induce the persistent current in the superconducting loop and wherein, in a control run (solid line), the superconducting loop is cooled off while the direct current (3 Amps) is running through the solenoid followed by the current through the solenoid being turned off which induces the persistent current in the superconducting loop, and in the current sweep reversal mode (dashed line) the initial stage is the same, but after the solenoid current is turned off, a smaller current (0.3 A) with opposite polarity is turned on again later and then the current is finally turned off; and

FIG. 4 illustrates the relaxation of the magnetic field produced by the persistent current running through the superconducting material when this current is induced by a standard induction protocol (the control run in FIG. 3) or by a modified current sweep method according to one aspect.

### DETAILED DESCRIPTION

The following description of particular aspect(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, parameters and/or sections, these elements, components, regions, layers, parameters, and/or sections should not be limited by these terms. These terms are only used to distinguish one element, component, region, layer, parameter, or section from another element, component, region, layer, parameter, or section. Thus, “a first element,” “component,” “region,” “layer,” “parameter,” or “section” discussed below could be termed a second (or other) element, component, region, layer, parameter, or section without departing from the teachings herein.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Provided is a device capable of inducing a current in a superconducting material. Also provided are processes of inducing a current in a superconducting material with reduced relaxation rate relative to prior processes. The device has utility for generating or maintaining a current in a superconducting material such as is useful for superconducting magnetic energy storage (SMES) as well as for magnetic resonance imaging (MRI) systems.

An exemplary device includes: a source of a magnetic field, optionally a solenoid, including a longitudinal axis, and optionally terminating with a first current terminal and a second current terminal; a coil former including an axis optionally substantially coaxial or making an angle with the axis of the magnetic field source, optionally a base in physical contact either directly or indirectly with the resistive solenoid and the coil former; and optionally a magnetic probe substantially coaxial with the resistive solenoid. A base, when present, is optionally indirectly in contact with said resistive solenoid. Indirect contact is optionally contact that includes or is through another element, optionally a solenoid support tube, or is merely within electromagnetic range of the base or of another element associate with a base, optionally a superconducting material. In some aspects, a base is absent.

As used in reference to an optional concentric or coaxial nature of the magnetic field source and coil former or a superconducting material, the term “substantially” is defined as the axis of an element being within 10% of the axis of the coil former or from the axis of another element. In some aspects, the magnetic field source, coil former, and superconducting material are coaxial.

In some aspects, a superconducting material is coaxial or substantially coaxial with the magnetic field source and the coil former where the term “substantially” is defined as per above. In other aspects, the superconducting material is not coaxial, but the axis of the superconducting material loop may be at any angle or any position relative to the axis of the magnetic field source as long as the orientation of the magnetic field source and the superconducting material loop is such that a current passing through the solenoid is capable of inducing a current in the superconducting material loop. In some aspects, the angle between a geometric center of a superconducting material loop and the axis of a magnetic field source or coil former is from 0 degrees to 89 degrees, or any value or range therebetween. Optionally, the angle between a line through the geometric center of a superconducting material loop and normal to a plane of the superconducting material loop and the axis of a magnetic field source or coil former is from 0 degrees to 45 degrees. Optionally, the angle between a line through the geometric center of a superconducting material loop and normal to a plane of the superconducting material loop and the axis of a magnetic field source is from 1 degree to 45 degrees.

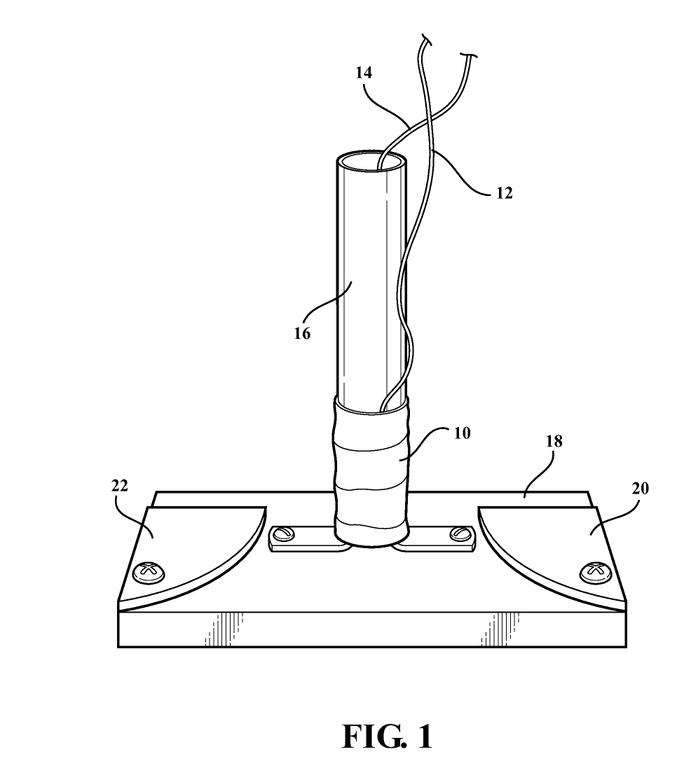

An exemplary device is illustrated in FIGS. 1-3 wherein element numbering is conserved between the figures. FIG. 1 illustrates a magnetic field source in the form of a solenoid 10 (or other source of a magnetic field) that is formed from a conducting wire wrapped about a central axis to form a longitudinal axis. The wire forming the resistive solenoid 10 includes a first current terminal 12 and a second current terminal 14, that optionally represent two opposing ends of the wire forming the resistive solenoid. A resistive solenoid is optionally formed of a wire made of copper, aluminum, or other conducting material. The resistive solenoid 10 is wrapped in the example of FIG. 1 around a solenoid support tube 16 that forms the longitudinal axis of the resistive solenoid. The diameter of the resistive solenoid is optionally from 5 mm to 20 mm, or any value or range therebetween. A resistive solenoid optionally has a diameter of 10 mm to 15 mm, optionally 10, 11, 12, 13, 14, or 15 mm. In one exemplary aspect as illustrated in FIG. 1, the resistive solenoid has a diameter of 6 mm. A solenoid support tube 16 is optionally formed from a material with less conductivity than the material used to form the resistive solenoid. Illustratively, a solenoid support tube is formed from brass. Also as illustrated in FIG. 1, the solenoid support tube is physically associated with a base 18. A base is optionally positioned normal or other relative position to the longitudinal axis of the resistive solenoid 10. A base is formed from any structural material that is physically associable with a solenoid support tube such as any polymeric material (e.g. polycarbonate, polyethylene terephthalate, etc.), wood, metal, other materials, or combinations thereof. In some aspects, a base is integral with the solenoid support tube. A base optionally includes two platforms 20, 22, that are suitable for attaching a superconducting material such that it is suspended above the plane of the base 18.

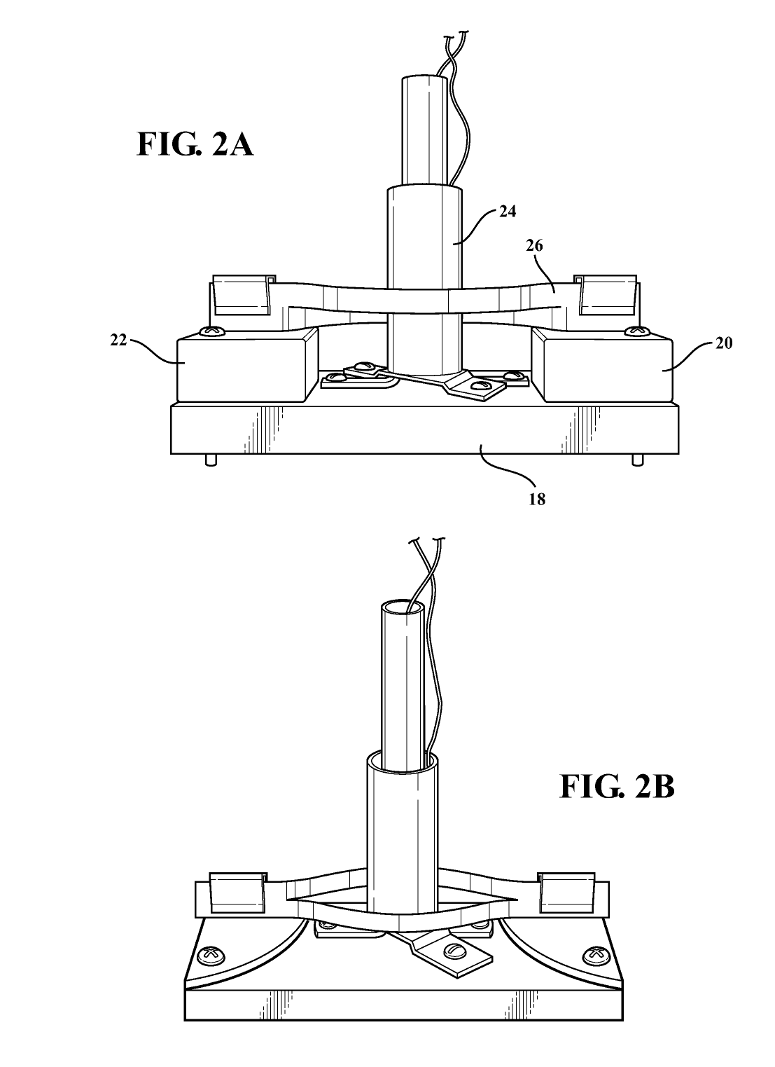

FIGS. 2A and 2B illustrate exemplary devices including a coil former 24 that is substantially cylindrical in structure including a central axis that is substantially coaxial with the longitudinal axis of the resistive solenoid that is housed within the coil former 24 such that the resistive solenoid cannot be seen in the illustration. The coil former includes an outer diameter or other cross sectional dimension that is sufficiently close to the outer linear dimension or diameter of the solenoid such that a magnetic field generated by the solenoid will have sufficient strength to result in a current in a superconducting material. A coil former 24 is optionally made of brass, a polymeric material, or other material. In some aspects, a coil former includes a polymeric material wrapped around the solenoid. In some aspects, a coil former is a sufficiently rigid material that will maintain the shape of the superconducting material loop when a solenoid is removed. A superconducting material 26 in the form of a closed loop structure is wrapped about the coil former 24 such that the coil former produces the closed loop with a geometric center including a vertical axis of the loop structure. The coil former is optionally suspended above the base by action of the resistive solenoid, superconducting material, or other mechanism, or is physically associated with the base. FIG. 2B illustrates a second aspect with the same arrangement of FIG. 2A with the exception that the supports position the superconducting material on a relatively lower position with respect to the resistive solenoid. A magnetic field probe can be inserted through the support tube 16, so that its position relative to the superconducting loop is known. By measuring the magnetic field and knowing the magnetic probe's position one can determine the magnitude of the persistent current running through the superconducting loop. The coefficient of proportionality between the magnetic field and the current can be determined either experimentally or calculated numerically.

It is appreciated that other arrangements of elements are possible. Illustratively, a magnetic field source may be located outside the loop of a superconducting material or a coil former. In all aspects, the magnetic field induced by the magnetic field source is of sufficient strength to induce current in the superconducting material and the dimensions of the magnetic field source, coil former, and superconducting material are not so great as to render the source incapable of inducing a current in a superconducting material located within or outside the magnetic field source.

A device is optionally operable with any form of superconducting material. A superconducting material is optionally a high temperature superconducting material where a high temperature material has a superconducting transition temperature of or in excess of 40° K., optionally 90° K. In some aspects, a superconducting material is or includes the composition of formula I:

ReM₂Cu₃O_{y} (I)

where Re is a rare earth metal or near rare earth metal, optionally Y, Gd, La, Lu, Sc, Sm, Nd, Yb, or combinations thereof, M is Ba, Sr, Ca, or combinations thereof, and y is sufficient to satisfy the valence demands of the composition. Illustrative examples of superconducting materials and methods of their manufacture are illustrated in U.S. Pat. No. 5,026,682; G. A. Levin, P. N. Barnes, J. Murphy, L. Brunke, J. D. Long, J. Horwath, and Z. Turgut, Appl. Phys. Lett., 2008; 93; 6: Art. No. 062504; Selvamanickam, et al., Supercond. Sci. Technol. vol. 23, no. 1, January 2010, Art. No. 014014, and Selvamanickam, et al., Supercond. Sci. Technol. vol. 26, no. 3, March 2013, Art. No. 035006. Illustrative superconducting materials are commercially available such as those from SuperPower Inc. (Schenectady, N.Y.).

A superconducting material is optionally in a layered or bulk form. A layered superconducting material optionally includes a plurality of layers, optionally 2, 3, 4, 5, 6, 7, 8, 9, 10, or more layers. To form a superconducting loop structure, a slit (e.g. 1 mm wide) may be made in a region within the planar layered superconducting material thereby forming a superconducting loop around the slit. The resulting coils are optionally coated in polyurethane or other protective coating to protect from water condensation over several thermal cycles.

A device functions to induce a current flow in a superconducting material by field cooling the superconducting material to a temperature at or below the critical temperature of the superconducting material while passing a current through the magnetic field source (optionally herein referred to as the primary current) so as to produce a magnetic field such that the magnetic flux that passes through the superconducting loops is close to that passing through the inner cross-section of the magnetic field source. In this sense, unlike in the case of two similar resistive winding, the magnetic field source and the superconducting coil are strongly coupled. At or below the critical temperature the magnetic flux that passes through the superconducting loop becomes frozen in and any changes in the external field (e.g. created by the magnetic field source) tend to be compensated by the induced current in the superconducting loops.

One issue with high temperature superconducting materials is that they exhibit an enhanced rate of relaxation in comparison with low-temperature superconductors. Thus, it is important to find effective methods of controlling the relaxation rate and reducing it to a desired or more optimal level. Provided are processes of inducing a current flow in a superconducting material that will demonstrate a reduced rate or relaxation relative to prior methods. A process is a modification of the current sweep reversal method. A process includes: generating a primary current optionally in the magnetic field source of the device as described above, the primary current comprising a first polarity and flowing for a first time, the magnetic field source in electromagnetic contact with a superconducting material such that switching off the primary current induces a current in said superconducting material for a second time or rest time; turning on a second primary current with the opposite polarity in the magnetic field source for a third time, and finally terminating the second primary current.

A first primary current optionally has amperage of at or between 0.1 to 10 A, or any value or range therebetween. A first primary current optionally has amperage of 0.1, 0.5, 1, 2, 3, 4, 5, 6, 7, 8, 9, or 10 A. A first primary current is optionally any value to generate a magnetic field flux density of 0 to 100 G or more as measured at the center of the solenoid.

A first primary current is continued through the resistive solenoid for a first time. A first time is any time sufficient to allow the cryogenic system to cool the superconducting material from the initial temperature, which is above or close to the critical temperature, to the operating temperature which is below the critical temperature of the superconducting material. A first time is optionally from 1 second to 1000 seconds or any value or range therebetween. A first time is optionally 100, 200, 300, 400, 500, 600, 700, or more seconds.

Following a first time, the first primary current through the magnetic field source is terminated for a second or rest time. A second time is optionally 0 seconds to 500 seconds, optionally 10, 50, 100, 200, 300, or 400 seconds.

Following a second time, a second primary current is generated through the resistive solenoid where a second primary current has a polarity opposite to the first primary current and, therefore, acts as a current reversal relative to the current used to induce current flow in the superconducting material. The second primary current optionally has a value of 0.01 to 3 A or any value or range therebetween. A second primary current optionally has a value of 0.1 to 0.5 A, optionally 0.2 to 0.4 A. The second primary current is maintained for a third time, or time sufficient for the relaxation processes to be mostly completed and temperature of the system to stabilize, optionally from 1 second to 100 seconds.

Following a third time, the second primary current through the magnetic field source is terminated. Due to the temperature of the superconducting material being below its critical temperature and being formed in a continuous loop, current continues to flow through the superconducting material after termination of current through the magnetic field source with the exception that current relaxation slowly reduces current flow through the superconducting material over time. By using the current sweep method as provided herein, the rate of relaxation is reduced relative to the relaxation rate observed after simply inducing the current without the current reversal according to the processes as provided herein.

Various aspects of the present invention are illustrated by the following non-limiting examples. The examples are for illustrative purposes and are not a limitation on any practice of the present invention.

### EXAMPLES

### Example 1

A resistive solenoid is formed of a copper wire of gauge 25 by winding around a brass solenoid support tube with a diameter of 12.6 mm a total of 300 times. The termini of the wire are connected to a direct current power source to generate a current though the solenoid.

A coil former made of brass and having an inner diameter of 18.8 mm and outer diameter of 22.1 mm suitable to fit over the resistive solenoid is placed over the resistive solenoid so as to entirely encompass the resistive solenoid.

A superconducting material purchased from SuperPower Inc. (SuperPower coated conductor product batch number M3-1060-3 SF12050-AP, with critical current of 309 A) was cut into samples of 110 mm in length. A 1 mm wide slit was milled in each of them resulting in the loops shown in FIG. 2. They were stacked together making a “coil” with 2 to 6 loops per coil and the main diameter of 22.6 mm. To preserve the quality of the superconducting material, the coils were encapsulated in polyurethane, which protected them from water condensation over multiple thermal cycles.

To measure the magnetic field created by current through the resistive solenoid, or the superconducting material, a magnetic probe (Hall sensor made by Lake Shore Cryotronics, model HGCA-3020) is inserted into the brass solenoid support tube.

### Example 2

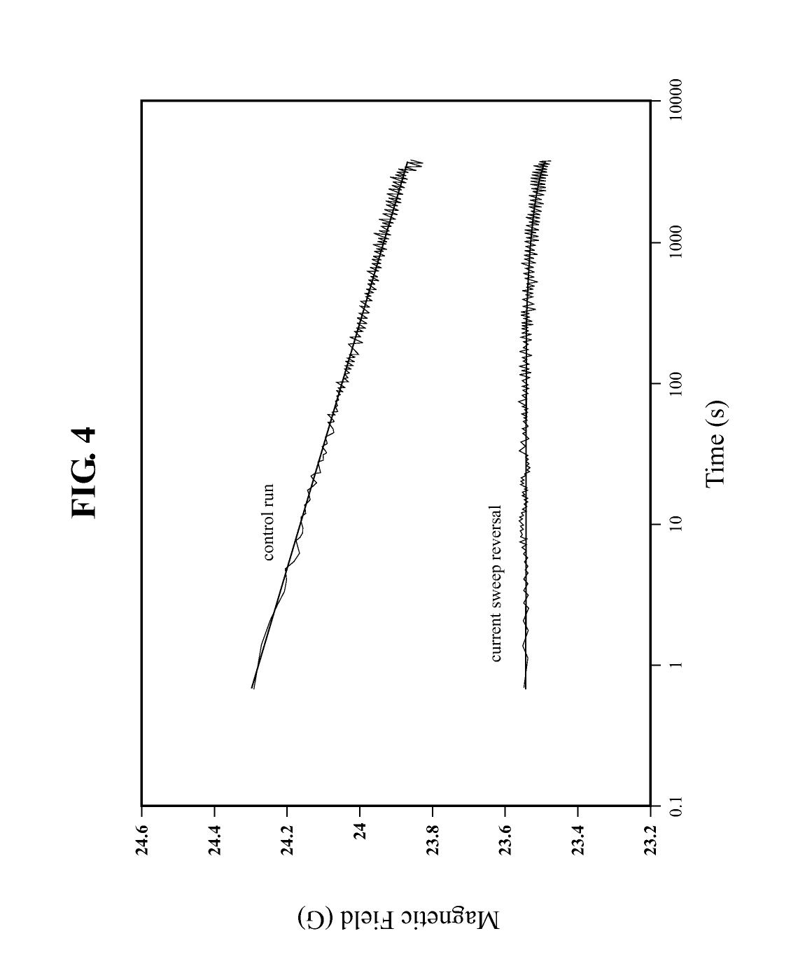

The device of Example 1 is immersed in liquid nitrogen to cool the superconducting material to a temperature below its critical temperature. During this time, a DC electric current is passed through the resistive solenoid at 3 A. When the critical temperature of the system of 77° K. is reached, the current is terminated which inducted the superconducting current through the superconducting material as observed by a Gaussmeter inserted into the inner diameter of the solenoid support tube. The magnetic field is directly proportional to the circulating in the loop superconducting current, so that the change in measured magnetic field directly reflects the change in the superconducting current. The changes in the superconducting current over time are depicted as the control run in FIG. 4 illustrating the expected rate of relaxation for this superconducting material.

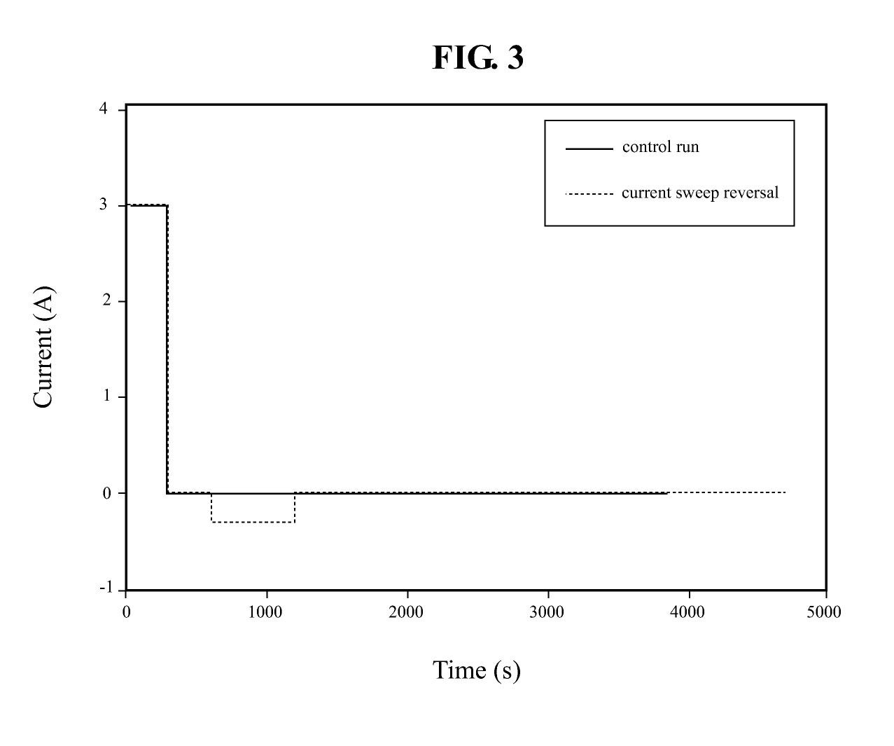

To reduce the rate of relaxation, a modified current sweep reversal is used to generate an electric current through the same type of superconducting material substantially as depicted by a dashed line in FIG. 3. The superconducting material and device are immersed in liquid nitrogen. During this time, a DC electric current is passed through the resistive solenoid at 3 A. When the critical temperature of the system of 77° K. is reached, the current is terminated which induced the superconducting current through the superconducting material as observed by a Gaussmeter inserted into the inner diameter of the solenoid support tube. A smaller current of 0.3 A and of opposite polarity is turned on for a 600 seconds (dotted line in FIG. 3). After this, the current is finally terminated resulting in a substantial reduction of the relaxation rate as illustrated by the lower curve in FIG. 4.

The time dependence evident in FIG. 4 is approximately a logarithmic decay, as expected following Equation 1:

$${B}_{z} = a - b ln \frac{t}{{t}_{o}} \qquad Eq . 1$$

where t₀ is an arbitrary unit of time (seconds in FIG. 4). The fit to the data gives the values of a=24.2 G and b=0.05 G for the control run. The relaxation after the current sweep reversal procedure is characterized by the parameters a=23.6 G and b=0.014 G.

To better understand the implications of the reduction in the relaxation rate consider a characteristic time τ representing current decay to a certain fraction of the initial value,

$$a - b ln \frac{τ}{{t}_{o}} = κ a , \qquad Eq . 2$$

so that

$$τ = {t}_{o} exp \{ \frac{( 1 - κ ) a}{b} \} . \qquad Eq . 3$$

For κ=½ this formula defines the half-life of the persistent current τ_{1/2}. Using the parameters a and b given above extremely large values of τ_{1/2} are obtained. Given the logarithmic nature of the temporal decay it makes more sense to consider a smaller reduction. For example, determine how long it takes to lose 1% of the initial value of the persistent current for control and using the modified current sweep process. This corresponds to κ=0.99. Then τ_{1%}=126 s for the control run and τ_{1%}=2.1×10⁷ s for the relaxation after the current sweep reversal. The results demonstrate that the method of modified current sweep reversal is very effective in suppressing the relaxation rate, even at relatively high temperature of 77° K.

Various modifications of the present invention, in addition to those shown and described herein, will be apparent to those skilled in the art of the above description. Such modifications are also intended to fall within the scope of the appended claims.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular aspects of the invention, but is not meant to be a limitation upon the practice thereof. The following claims, including all equivalents thereof, are intended to define the scope of the invention.

We claim:

1. A device for inducing a current in a superconducting material comprising:
a magnetic field source comprising a longitudinal axis; and
a coil former housed inside or outside said magnetic field source and within a distance from said magnetic field source such that a magnetic field generated by said magnetic field source is of sufficient strength to induce a current in a superconducting loop supported by said coil former.

2. The device of claim 1 wherein said magnetic field source is a solenoid.

3. The device of claim 1 further comprising a superconducting material having a closed loop structure wherein said closed loop forms a geometric axis normal to a plane of the closed loop and passing through a geometric center of the loop, said geometric axis substantially coaxial with or oriented at an angle to said longitudinal axis of said magnetic field source.

4. The device of claim 1 wherein said coil former is in physical contact with a base, said base in physical contact with said magnetic field source.

5. The device of claim 2 wherein said magnetic field source has a diameter of 10 millimeters to 15 millimeters.

6. The device of claim 1 further comprising a support tube surrounded by said magnetic field source, said support tube comprising brass.

7. The device of claim 1 wherein said coil former comprises brass.

8. The device of claim 1 further comprising a power source capable of producing a current in said magnetic field source.

9. The device of claim 3 wherein said superconducting material comprises a rare earth metal.

10. The device of claim 9 wherein said rare earth metal is selected from the group consisting of yttrium, samarium, neodymium, and gadolinium.

11. The device of claim 9 wherein said superconducting material comprises barium copper oxide.

12. The device of claim 9 wherein said superconducting material comprises a plurality of independent layers of superconducting material.

13. The device of claim 1 further comprising a current flowing through said magnetic field source.

14. The device of claim 13 wherein said current has an amperage in the range of 0.1 amperes to 10 amperes.

15. A process of inducing current flow through a superconducting material comprising:
generating a first primary current in a magnetic field source, said first primary current comprising a first polarity and flowing for a first time, said magnetic field source in electromagnetic contact with a superconducting material such that said first primary current produces a finite magnetic flux through the superconducting material;
terminating said first primary current for a second time;
generating a second magnetic flux by generating a second primary current with a second polarity through said magnetic field source for a third time, said second polarity opposite to said first polarity; and
terminating said second primary current.

16. The process of claim 15 wherein said superconducting material comprises a closed loop structure wherein said closed loop forms a geometric axis normal to a plane of the closed loop and passing through a geometric center of the loop.

17. The process of claim 15 wherein said superconducting material comprises a rare earth metal.

18. The process of claim 17 wherein said rare earth metal is selected from the group consisting of yttrium, samarium, neodymium, and gadolinium.

19. The process of claim 15 wherein said superconducting material comprises barium copper oxide.

20. The process of claim 15 wherein said superconducting material comprises a plurality of independent layers of superconducting material.
